(19) United States
(12) Patent Application Publication
(10) Pub. No.: US 2005/0071270 A1
(43) Pub. Date: Mar. 31, 2005

(54) Process for remote recovery and creation of machine specific authentication keys for systems

(76) Inventors: Christopher W. Ramirez, Austin, TX (US); James A. Howell JR., Georgetown, TX (US)

Correspondence Address: Stephen A. Terrile;HAMILTON & TERRILE, LLP, PO Box 203518, Austin, TX, 78720, US

(21) Appl. No.: 10/672,130

(22) Filed: Sep. 26, 2003

(51) Int. Cl. G06F 17/60; H04K 1/00; H04L 9/00

(52) U.S. Cl. 705/50; 705/14

(57) ABSTRACT

A method for enabling remote restoration of a purchase verification. The method includes obtaining a value that uniquely identifies an information handling system, obtaining a promotion code value that identifies a benefit, linking the value that uniquely identifies the information handling system with the promotion code value for the information handling system, providing the promotion code value to the information handling system to re-enable the benefit, and during remote restoration, obtaining the promotion code value for the information handling system by providing the value that uniquely identifies the information handling system.

### BACKGROUND OF THE INVENTION

1. Field of the Invention

This invention relates generally to purchase identification and verification, and, more particularly, to a process for restoring upgrade keys or promotional offers using unique identifiers.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A make-to-order computer manufacturer takes orders from a purchaser during an order transaction and accordingly assembles and configures a computer system conforming to the specifications requested by the purchaser. During the order transaction, the purchaser specifies the desired components of the computer system being ordered. At the time that the computer is assembled and configured at the factory, the computer manufacturer utilizes the information provided by the purchaser during the order transaction to assemble and configure the computer system according to the purchaser's specifications.

Make-to-order computer manufacturers have begun offering additional services, products, and other benefits along with the purchase of a computer. That is, at the time a purchaser specifies the desired components of the computer system during the order transaction, the purchaser can also specify additional services, products, or benefits that the purchaser wishes to purchase. For example, when the purchaser orders a computer system he can, at the same time, order and pay for Internet Service Provider (“ISP”) services.

ISP services are related to communications that occur over the Internet. The Internet is a vast system of computers and computer networks that are interconnected through communication links. The interconnected computers exchange information, which may include information necessary to conduct purchases and other commercial activities over the Internet.

Each of the thousands of individual networks and organizations that make up the Internet is run and financed separately. A key component of these individual networks and organizations are the individual local networks that provides Internet access for individual users, known as Internet Service Providers (“ISP's”). An individual user that wishes to access the Internet pays the ISP a fee, such as a monthly connection rate. In return, the ISP acts as the intermediary between the user and the network “backbone” servers that provide access to the various networks within the Internet.

The practice of offering additional products, services, and benefits along with the purchase of a computer system raises several security, logistics, and customer experience concerns. One such concern arises from the fact that a purchaser of the manufacturer's computer systems may or may not order the ISP service or other offered products and services. It is therefore necessary to devise a means by which the ISP or other provider of goods or services can determine, when the purchaser attempts to access the ISP or other provider, whether or not particular goods or services that the purchaser is requesting are included. Another concern is that the ISP or other provider must have a manner of identifying the purchaser. If the purchaser has a limited amount of monthly ISP access or a limited amount of other goods or services, the provider must identify the purchaser so that goods or services requested in an amount exceeding the prepaid amount may be tracked and charged to the proper person. Ideally, these concerns should be addressed in a way that minimizes implementation costs and requires as little action as possible from the purchaser.

One approach for addressing the above concerns is to issue a “product key” or password to the purchaser that encodes whether or not particular goods or services are included and, if so, identifies the good or services. The product key may be printed on a certificate that is delivered with the computer system. Alternatively, the product key may be generated by computer and e-mailed to the purchaser. When the purchaser has received the computer, he manually types the product key into the computer when attempting to gain access to the pre-purchased goods or services. This approach presents several disadvantages. First, with either the printed or computer-generated approach, the customer will be denied access unless he properly types the product key into the computer when it is requested. This feature could prevent, due to a typographical error, the purchaser from accessing goods or services for which he has already paid. With the printed product key approach, there is also the risk that the certificate bearing the printed product key will become destroyed, lost, or otherwise inaccessible to the purchaser.

One issue that arises when using a product key relates to when a client performs a software re-install or hard drive replacement on a computer system which includes a product key. In this situation, there is not a seamless way to restore the promotional offer or client upgrade keys to the computer system, or to even know what offers the user of the computer system was originally authorized to purchase. Often the client contacts the vendor via telephone to obtain the product keys and then manually re-enters the product keys onto the computer system.

### SUMMARY OF THE INVENTION

A software-generated purchase verification key (“product key”) is generated and stored on an information handling system at the factory where the make-to-order information handling system is assembled. If a re-install of a base client occurs before registration (either via a manual re-install or as a result of a hard drive replacement), the client connects to the restore server, the restore server reads the service tag, and the restore server transparently provides the upgrade key back to the client thus enabling all features and capabilities associated with the product key. With a promotional offer, the offer is linked to the information handling system as well.

Such a process advantageously helps to reduce vendor customer service calls and improves the overall customer experience for system failures or hard drive restores. Such a process provides an important piece of an overall services or application management processes.

In one embodiment, the invention relates to a method for enabling remote restoration of a purchase verification. The method includes obtaining a value that uniquely identifies an information handling system, obtaining a promotion code value that identifies a benefit, linking the value that uniquely identifies the information handling system with the promotion code value for the information handling system, providing the promotion code value to the information handling system to re-enable the benefit, and during remote restoration, obtaining the promotion code value for the information handling system by providing the value that uniquely identifies the information handling system.

In another embodiment, the invention relates to a process for remote creation of a system specific key for a benefit purchased post point of sale. The process includes obtaining a value that uniquely identifies an information handling system, obtaining a promotion code value that identifies the benefit, linking the value that uniquely identifies the information handing system with the product code value, creating the system specific key for the benefit purchased post point of sale based upon the value that uniquely identifies the information handling, and providing the promotion code value to the information handling system to enable benefit.

In another embodiment, the invention relates to a system for enabling remote restoration of a purchase verification. The system includes a restore module. The restore module is configured to obtain a value that uniquely identifies an information handling system, obtain a promotion code value that identifies a benefit, link the value that uniquely identifies an information handling system with the product code value for the information handling system, provide the promotion code value to the information handling system to re-enable benefit, and during remote restoration, obtain the promotion code value for the information handling system by providing the value that uniquely identifies the information handling system.

In another embodiment, the invention relates to a system for remote creation of a system specific key for a benefit purchased post point of sale which includes a restore module. The restore module is configured to obtain a value that uniquely identifies an information handling system, obtain a promotion code value that identifies the benefit, link the value that uniquely identifies the information handing system with the product code value, create the system specific key for the benefit purchased post point of sale based upon the value that uniquely identifies the information handling, and, provide the promotion code value to the information handling system to enable benefit.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an information handling system.

FIG. 2 shows a block diagram of an Internet connection.

FIG. 3 shows a flow chart of a hard drive restore process.

FIG. 4 shows a flow chart of a post point of sale software restore process.

FIG. 5 shows a flow chart of a product key based registration process.

The use of the same reference symbols in different drawings indicates identical items unless otherwise noted.

### DETAILED DESCRIPTION

It is to be understood that the present invention may be utilized to verify and authorize on-line access to any service, product, or benefit that has been included with the order of a computer system. These services, products and benefits may include, but are not limited to, ISP services, security services, music subscriptions, photo subscriptions, premium internet content, and other subscription products or services. For simplicity, the discussion below presents an example where the service is an internet service provider (ISP) service. It will be understood, however, that many other types of services, products, and benefits fall within the scope of the present invention, such as access to on-line or standalone software, on-site or on-line technical support or maintenance agreements, and on-line banking, stock trading, bill-paying or other financial services.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

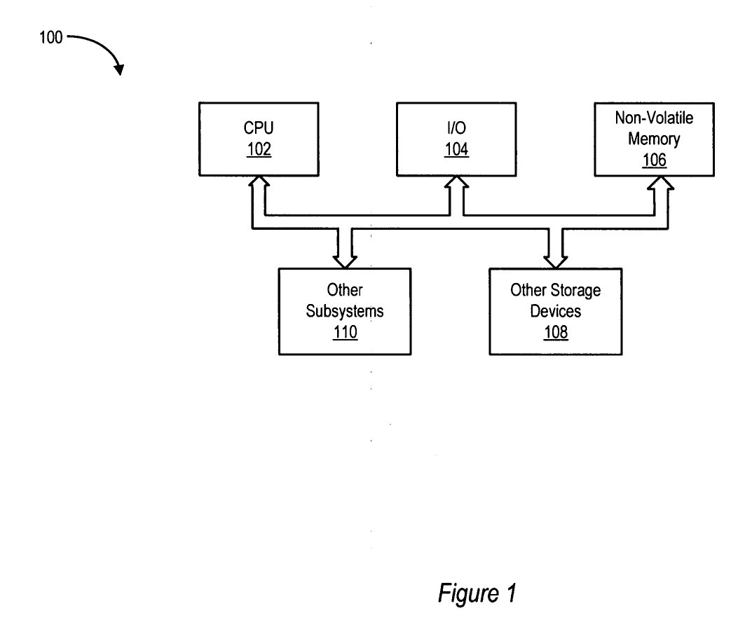

Referring to FIG. 1, a system block diagram of an information handling system 150 is shown having features configured in accordance with the on-line store 110 as discussed. The information handling system 100 includes a processor 102, input/output (I/O) devices 104, such as a display, a keyboard, a mouse, and associated controllers, nonvolatile memory 106 such as read only memory (ROM), electronically programmable read only memory (EPROM), a hard disk and drive and other/or other types of nonvolatile memory 106, and other storage devices 108, such as a floppy disk and drive and other memory devices, and various other subsystems 110, all interconnected via one or more buses 112. The non-volatile memory may include a basic input output system (BIOS) on which is stored a unique system identifier, such as, e.g., a service tag.

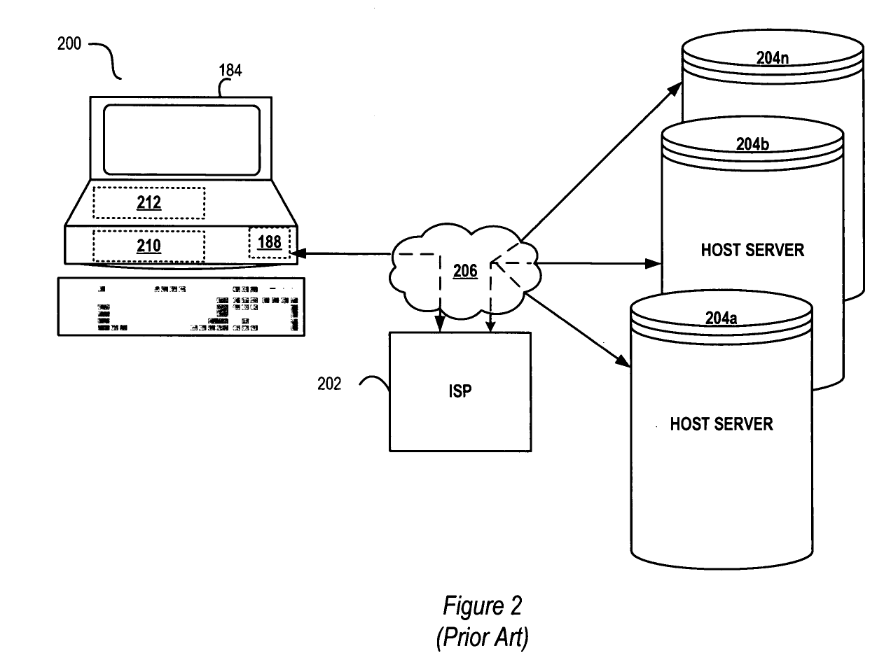

FIG. 2 illustrates that, when an individual user establishes a connection with the Internet 206 through the services of an ISP 202, the connection usually consists of four basic parts. First, the user interacts with a client computer 200, the client computer being a PC computer system or similar device. The client computer 200 includes a modem 188, communications software 210 and “browser” software 212. The modem 188 is the physical means by which the client computer 100 sends and receives communications to and from other computers and networks, including the Internet 206. The communications software 210 provides software support for those communications.

The second part of the connection is the ISP 202. The ISP 202 acts as a conduit for individuals to connect to the third part of the connection, the third part being the host computer, known as the “server” 204, at the other end of the connection. The ISP 202 receives a request for access from the client computer 100. Typically, the ISP 202 includes a collection of modems that accept multiple incoming requests simultaneously.

The ISP 202 processes the request and connects the user computer 100 to the Internet “backbone”, the backbone being very high-capacity lines that carry large amounts of Internet traffic. Several different data communication lines are available to connect a computer or computer system to the Internet. Common data communication lines include, but are not limited to, analog modems (14.4 Kbaud-56 Kbaud), ISDN (Integrated Services Digital Network), T1 lines, and Fractional T1 lines.

The third part of the Internet connection is the host server 204. The host runs special software that receives and reads requests sent from the browser 112. The browser 121 sends requests to a specific server computer 204a, 204b, 204n on the Internet to retrieve a specific document or Web page, once the Internet connection is established. Host servers 204 differ from typical client computers 100 in that host servers 204 can handle multiple telecommunications connections at one time. The host server 204 retrieves the appropriate information to be sent to the client computer 100. The server computer 204 is connected to the Internet backbone, and sends the appropriate information back to the client computer 100.

The fourth part of the Internet connection is the communications networks 206 that link together the first three components 100, 202, 204. FIG. 2 illustrates that the Internet connection is complete when the request from the client computer 100 results in a link being established with the host server 204.

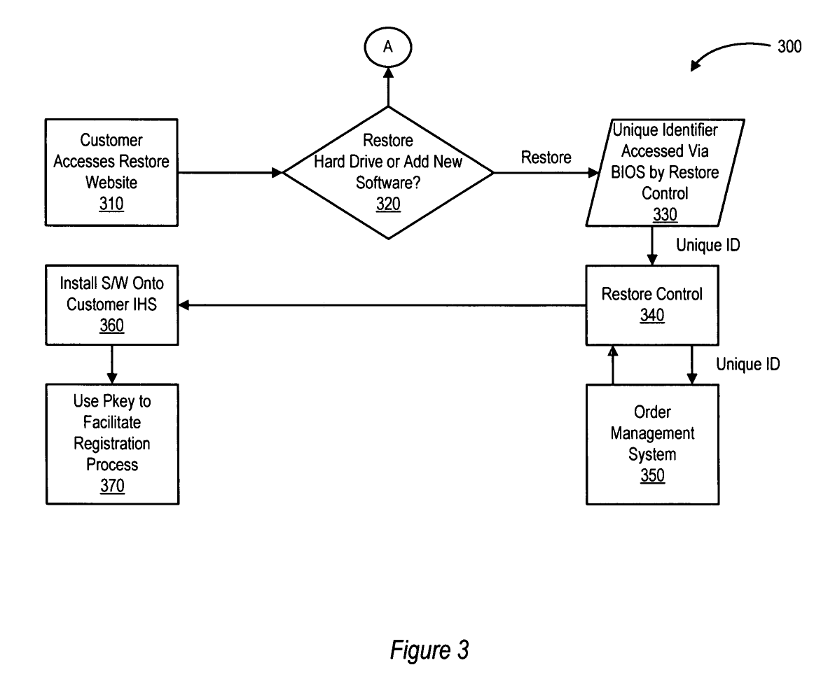

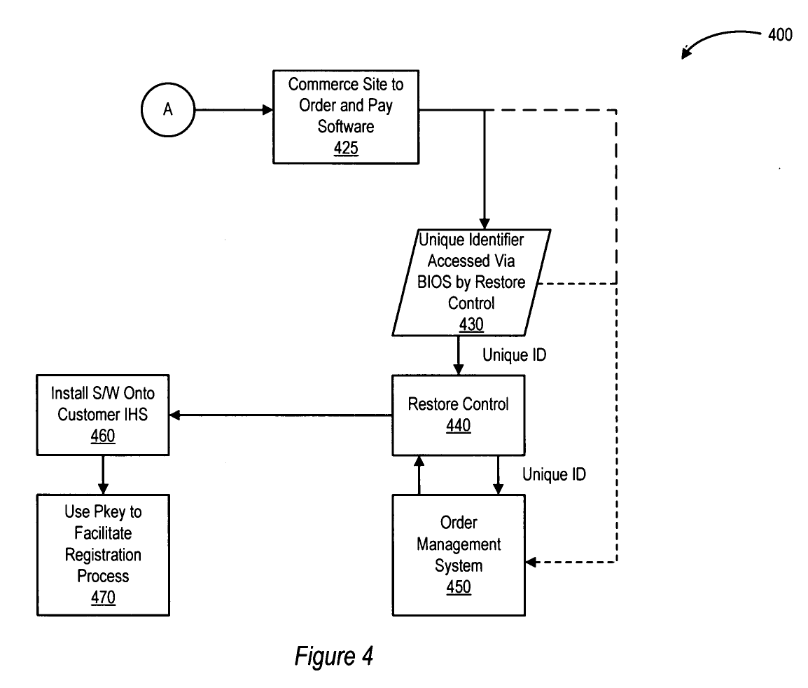

FIG. 3 shows a flow chart of the operation of a hard drive restore process. More specifically, when a customer desires to perform a hard drive restore process or a post point of sale software process, the customer accesses a restore system 300. The customer accesses the restore system 300 by first accessing a manufacturer restore module, for example, via a restore web site, at step 310. The restore system 300 then queries the customer to determine whether the customer desires to restore a hard drive to the customer's information handling system or to add new software to the customer's information handling system at step 320. If the customer indicates a desire to add new software to the information handling system, then the restore module 300 transfers control to a post point of sale module 400 (see FIG. 4).

If the customer indicates a desire to perform a hard drive restoration process, then the restore system 300 determines whether the information handing system 100 was registered at the time of the data loss by accessing a unique identifier for the information handling system. In one embodiment, the unique identifier may be the service tag that is stored within non-volatile memory, such as in the BIOS of the information handling system 100. The restore control module 340 of the restore system 300 then accesses the unique identifier at step 330. The restore control module 340 provides the unique identifier to a manufacturer order management system 350. The order management system 350 provides offer information that is specific to the information handling system 100 that is identified by the particular unique identifier to the restore control module 340.

The restore control module 340 then recreates machine specific keys from the unique identifiers and the specific offer information. The restore control module 340 compares the recreated keys and software to existing keys and software on the customer information handing system to determine which software or keys need to be restored to the hard drive. Any missing software or key is then provided to customer to be loaded onto the new hard drive at step 360. For example, a customer may have re-installed software from a back-up disk, but not have the keys provided by the manufacturer for the software.

After the software is installed onto the customer hard drive, the restore system 300 uses a product key module to facilitate the registration process for the software 360.

FIG. 4 shows a flow chart of a post point of sale software restore process. More specifically, when a customer has indicated a desire to order software that has not previously been installed on the customer information handling system 100 (see, e.g., FIG. 3), the customer accesses a post point of sale module 400. The existing customer accesses a commerce module to order and pay for the desired software at step 425.

After ordering the software, the restore control module 440 accesses the information handling system unique identifier at step 430. This unique identifier may be stored within the BIOS of the information handling system. One example of a unique identifier is an information handling system service tag. This is provided to update the order management system.

After accessing the commerce site, control transfer to an order management system 450 which queries service tags and associates the newly ordered software with the service tag. The system 400 then proceeds to the restore module 440 which interacts with the order management system 450. The restore module 440 uses a customer identifier or a service tag to process the software order. The restore control module 440 provides the order management system with the system unique identifier at step 535. The order management system 450 then provides the restore control module 440 with any system specific offers.

Next, the restore control module 440 generates any new system specific keys from the unique identifier and the system specific offers. The restore control module 440 then compares the new system specific keys and the software to existing keys and software that is stored within the customer information handling system 100. Any software to be installed is then provided to the customer to be loaded onto the customber information handling system 100 at step 460.

After the software is installed onto the customer information handling system 100, the restore system 400 uses a product key module to facilitate the registration process for the software at step 470.

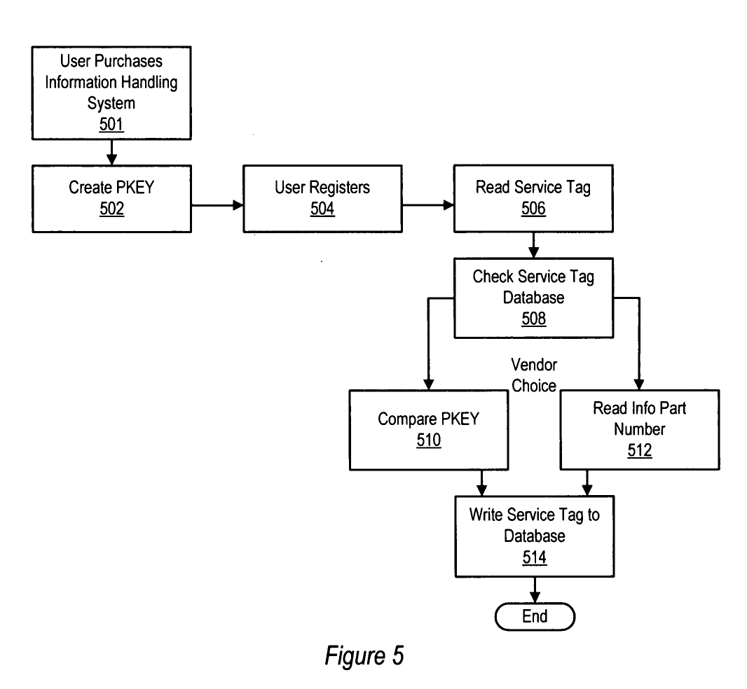

FIG. 5 shows a flow chart of a product key based registration process. More specifically, when a user purchases an information handling system at step 501, the manufacturing process begins. During the manufacturing process for the information handling system, a product key (PKEY) is loaded onto the information handling system 100 at step 502. The product key is created during a factory download process and includes information relating to services and/or software that were purchased along with the information handling system 100. When the user receives the information handling system 100, then the user starts a registration process for the services and/or software that were purchased along with the information handling system at step 504. During the registration process, the service tag is read from the information handling system 100 to verify that the information handling system corresponds to the manufacturer at step 506. The service tag may be read from the BIOS of the information handling system or from any other location in which the service tag is stored. The registration process then proceeds by checking a service tag database to assure that the information handling system 100 has not already registered for a particular promotion, service or software at step 508.

The registration process then proceeds down one of two paths depending on the preference of the service provider. In one operation, the registration process compares a product key to an information part number and if the comparison is successful, proceeds with the registration at step 510. In another operation, the registration reads the info part number and proceeds with the operation at step 512. With either operation, the service tag is written to the service tag database to ensure that the same information handling system does not register more than once for the same promotion at step 514. The registration process then completes execution.

### OTHER EMBODIMENTS

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while the restore in the described environment is to a hard drive, it will be appreciated that a restore of software onto any type of non-volatile memory is contemplated.

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A method for enabling remote restoration of a purchase verification, comprising:
obtaining a value that uniquely identifies an information handling system;
obtaining a promotion code value that identifies a benefit;
linking the value that uniquely identifies the information handling system with the promotion code value for the information handling system;
during remote restoration, obtaining the promotion code value for the information handling system by providing the value that uniquely identifies the information handling system; and,
providing the promotion code value to the information handling system to re-enable the benefit.

2. The method of claim 1, further comprising;
installing application software in an information handling system memory when the information handling system is assembled at a manufacturing facility; and,
linking any promotion code values with the value that uniquely identifies the information handling system within an order management system.

3. The method of claim 1, wherein; the promotion code value includes a system specific key that enables a benefit.

4. The method of claim 3 wherein:
the benefit was erased prior to registration of the benefit; and,
the method includes placing the keys and software back onto the information handling system.

5. The method of claim 1 wherein:
the value that uniquely identifies an information handling system is a service tag.

6. The method of claim 1 further comprising:
determining whether any promotion code value or benefit is present on the information handling system during the remote restoration; and
comparing an expected promotion code value and expected benefit to any promotion code value or benefit stored on the information handling system to determine which promotion code value and benefit to restore to the information handling system.

7. A process for remote creation of a system specific key for a benefit purchased post point of sale comprising
obtaining a value that uniquely identifies an information handling system;
obtaining a promotion code value that identifies the benefit;
linking the value that uniquely identifies the information handing system with the product code value; and,
creating the system specific key for the benefit purchased post point of sale based upon the value that uniquely identifies the information handling; and,
providing the promotion code value to the information handling system to enable benefit.

8. The method of claim. 7, wherein;
the promotion code value includes the system specific key; and,
the system specific key enables a benefit.

9. The method of claim 7 wherein:
the value that uniquely identifies an information handling system is a service tag.

10. The method of claim 7 further comprising:
determining whether any promotion code value or benefit is present on the information handling system during the remote creation; and
comparing an expected promotion code value and expected benefit to any promotion code value or benefit stored on the information handling system to determine which promotion code value and benefit to provide to the information handling system.

11. A system for enabling remote restoration of a purchase verification, comprising:
a restore module, the restore module being configured to
obtain a value that uniquely identifies an information handling system;
obtain a promotion code value that identifies a benefit;
link the value that uniquely identifies an information handling system with the product code value for the information handling system;
during remote restoration, obtain the promotion code value for the information handling system by providing the value that uniquely identifies the information handling system; and,
provide the promotion code value to the information handling system to re-enable benefit.

12. The system of claim 11 further comprising
an install module, the install module installing application software on an information handling system memory when the information handling system is assembled at a manufacturing facility; and,
a link module, the link module linking any promotion code values with the value that uniquely identifies the information handling system within an order management system.

13. The system of claim 11, wherein;
the promotion code value includes a system specific key that enables a benefit.

14. The system of claim 13 wherein:
the benefit was erased prior to registration of the benefit; and,
the restore module includes instructions for placing the keys and software back onto the information handling system.

15. The system of claim 11 wherein:
the value that uniquely identifies an information handling system is a service tag.

16. The system of claim 11 further comprising:
a determining module, the determining module determining whether any promotion code value or benefit is present on the information handling system during the remote restoration; and
a comparing module, the comparing module comparing an expected promotion code value and expected benefit to any promotion code value or benefit stored on the information handling system to determine which promotion code value and benefit to restore to the information handling system.

17. A system for remote creation of a system specific key for a benefit purchased post point of sale comprising
a restore module, the restore module configured to:
obtain a value that uniquely identifies an information handling system;
obtain a promotion code value that identifies the benefit;
link the value that uniquely identifies the information handing system with the product code value; and,
create the system specific key for the benefit purchased post point of sale based upon the value that uniquely identifies the information handling; and,
provide the promotion code value to the information handling system to enable benefit.

18. The system of claim 17, wherein;
the promotion code value includes the system specific key; and,
the system specific key enables a benefit.

19. The system of claim 17 wherein:
the value that uniquely identifies an information handling system is a service tag.

20. The system of claim 17 the restore module is further configured to:
determine whether any promotion code value or benefit is present on the information handling system during the remote creation; and
compare an expected promotion code value and expected benefit to any promotion code value or benefit stored on the information handling system to determine which promotion code value and benefit to provide to the information handling system.
